(19) United States
(12) Patent Application Publication
(10) Pub. No.: US 2014/0369502 A1
(43) Pub. Date: Dec. 18, 2014

(54) DIGITAL AUDIO SOFTWARE STEREO PLUGIN

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/205,269

(22) Filed: Mar. 11, 2014

Related U.S. Application Data
(60) Provisional application No. 61/776,696, filed on Mar. 11, 2013.

(51) Int. Cl. G10L 19/008

(52) U.S. Cl. CPC G10L 19/008
USPC 381/2

(57) ABSTRACT

A process and system for enhancing and customizing audio recording and editing comprises receiving an input audio sound; setting a preset for the input audio sound to create a presetted audio sound; tone adjusting the presetted audio sound to create a tone adjusted presetted audio; expanding the tone adjusted presetted audio in a horizontal plane to create an presetted tone adjusted expanded audio; and outputting the presetted tone adjusted expanded audio. There are three options for selecting the preset. These are: ten or more presets for different genres of music; auto-preset that is selected by genre in metadata of playback material; and a single generic preset that covers all music. Presetting comprises parallel processing the input audio through: a module that is a low pass filter with dynamic offset; an envelope controlled bandpass filter; a high pass filter; adding an amount of dynamic synthesized sub bass to the audio; and combining the four treated audio signals in a summing mixer with the original audio. The adjustment step comprises a first section for adjusting a low frequency tone; a second section for adjusting a mid frequency tone; a third section for adjusting a high frequency tone; and mixing the audio outputs processed by the first, second and third sections to produce an output audio sound.

### CROSS-REFERENCE TO RELATED PATENT APPLICATIONS

Embodiments of the present invention relate to U.S. (Provisional/CIP . . . ) Application Ser. No. 61/776,696, filed Mar. 11, 2013, entitled “DIGITAL AUDIO SOFTWARE PLUGIN”, the contents of which are incorporated by reference herein and which is a basis for a claim of priority.

### BACKGROUND OF THE INVENTION

An audio plug-in, in computer software, is a plug-in that can add or enhance audio-related functionality in a computer program. A digital audio software plugin is generally used to modify or enhance audio. It can be a standalone or used in conjunction with another audio program as an insert, if that program allows. The applications of these plugins range from consumer to audio professionals such as recording engineers. Such functionality may include digital signal processing or sound synthesis. Audio plug-ins usually provide their own user interface, which often contains GUI widgets that can be used to control and visualize the plug-in's audio parameters¹. ¹ http://en.wikipedia.org/wiki/Audio_{—plug-in}

Real-Time AudioSuite (RTAS) is a format of audio plug-in developed by Digidesign, currently Avid Technology for their Pro Tools LE, and Pro Tools M-Powered systems, although they can be run on Pro Tools HD and Pro Tools TDM systems. RTAS plug-ins use the processing power of the host computer rather than DSP cards used in the Pro Tools HD systems.² ² http://en.wikipedia.org/wiki/Real_Time_AudioSuite

As the name suggests, the plug-in architecture is designed to be run in real-time, mimicking hardware inserts on traditional mixing console. This is in contrast to rendering files out of time with effects applied directly to the audio, which in Pro Tools is facilitated by AudioSuite Plug-ins. Avid's AAX format, which runs on both native CPU and Pro Tools HDX DSP, is the replacement for RTAS³. ³ See, n.1, above.

The typical “tone control is a static setting that can increase or decrease a fixed amount at a single frequency and bandwidth. While this does allow the user to customize a sound to his preference, as soon as anything changes this setting may not be desirable and the user will either accept compromise or be continually changing the amounts as different content is played⁴. ⁴ http://en.wikipedia.org/wiki/Tone_control_circuit

What is needed is a digital audio plugin that improves the sound quality of the conventional systems.

### SUMMARY OF THE PREFERRED EMBODIMENT(S)

A process and system for enhancing and customizing audio recording and editing comprises receiving an input audio sound; setting a preset for the input audio sound to create a presetted audio sound; tone adjusting the presetted audio sound to create a tone adjusted presetted audio; expanding the tone adjusted presetted audio in a horizontal plane to create an presetted tone adjusted expanded audio; and outputting the presetted tone adjusted expanded audio.

According to one embodiment, there are three options for selecting the preset: two or more presets for different genres of music; auto-preset that is selected by genre in metadata of playback material; and a single generic preset that covers all music. Presetting comprises parallel processing of the input audio through: a module that is a low pass filter with dynamic offset; an envelope controlled bandpass filter; a high pass filter; adding an amount of dynamic synthesized sub bass to the audio; and combining the four treated audio signals in a summing mixer with the original audio. The adjustment step comprises a first section for adjusting a low frequency tone; a second section for adjusting a mid frequency tone; a third section for adjusting a high frequency tone; and mixing the audio outputs processed by the first, second and third sections to produce an output audio sound.

The inventive Digital Audio Software Stereo Plugin will allow the process to be used on multiple channels with individual controls, or used as an insert on the final output for the complete mixed audio.

### BRIEF DESCRIPTION OF THE DRAWINGS

FIG. 1 is a block diagram of the basic elements and signal flow according to an embodiment of the present invention.

FIG. 2 shows a typical user interface according to an embodiment of the present invention.

FIG. 3 is a detailed block diagram according to an exemplary embodiment of the present invention.

FIG. 4 is a block diagram for the Compare module according to an embodiment of the present invention.

### DETAILED DESCRIPTION OF THE PREFERRED EMBODIMENT(S)

The inventive process of the present application comprises three stages, a Stereo Processing module (also referenced as the Max Sound Processor), a tone adjustment module (also referenced as the Wave Adjustment Tool (WAT)), and a Stereo Expander module.

Further details of the inventive Stereo Processor will now be described with reference to the drawings.

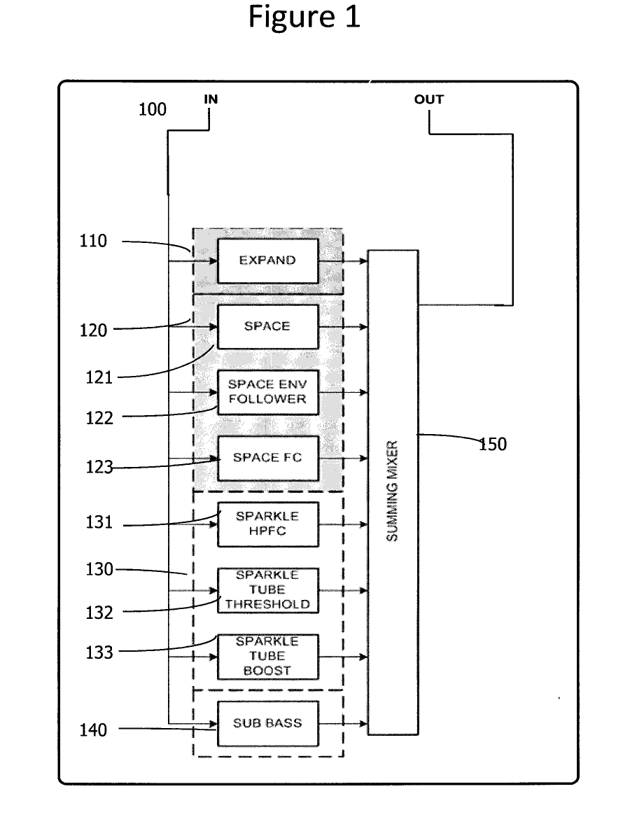

Referring to FIG. 1, Stereo Audio input 100 is processed, in parallel, by several modules as follows. EXPAND 110 is preferably a 4 pole digital low pass filter with an envelope follower for dynamic offset (fixed envelope follower). This allows the output of the filter to be dynamically controlled so that the output level is equal to whatever the input is to this filter section. For e.g., if the level at the input is −6 dB, then the output will match that. Moreover, whenever there is a change at the input, the same change will occur at the output regardless of either positive or negative amounts. The frequency for this filter is, e.g., 20 to 20 k hertz, which corresponds to a full range. In one embodiment, the purpose of EXPAND 110 is to “warm up” or provide a fuller sound as waveform 100 passes through it. The original audio 100 passes through, and is added to the effected sound for its output. As the input amount varies, so does the phase of this section. This applies to all filters used in this software application. Preferably all filters are of the Butterworth type.

Next, we discuss SPACE 120. SPACE 120 refers to the block of three modules identified by reference numerals 121, 122 and 123. The first module SPACE 121—which follows EXPAND 110 envelope follower, sets the final level of this module. This is the effected signal only, without the original. SPACE ENV FOLLOWER 122 tracks the input amount and forces the output level of this section to match. SPACE FC 123 sets the center frequency of the 4 pole digital high pass filter used in this section. This filter also changes phase as does EXPAND 110.

SPACE blocks 120 are followed by the SPARKLE 130 blocks. Like SPACE 120, there are several components to SPARKLE. SPARKLE HPFC 131 is a 2 pole high pass filter with a preboost which sets the lower frequency limit of this filter. Anything above this setting passes through the filter while anything below is discarded or stopped from passing. SPARKLE TUBE THRESH 132 sets the lower level at which the tube simulator begins working. As the input increases, so does the amount of the tube sound. The tube sound adds harmonics, compression and a slight bit of distortion to the input audio 100. This amount increases slightly as the input level increases. SPARKLE TUBE BOOST 133 sets the final level of the output of this module. This is the effected signal only, without the original.

Next, the SUB BASS 140 module is discussed. This module takes the input signal and uses a low pass filter to set the upper frequency limit to about 100 Hz. An octave divider occurs in the software that changes the input signal to lower by an octave (12 semi tones) and output to the only control in the interface, which is the level or the final amount. This is the effected signal only, without the original.

Outputs from the above modules 110 to 140 are directed into SUMMING MIXER 150 which combines the audio. The levels going into the summing mixer 150 are controlled by the various outputs of the modules listed above. As they all combine there is interaction in phase, time and frequencies that occur dynamically. These changes all combine to create a very pleasing audio experience for the listener in the form of “enhanced” audio content. For example, a change in a single module can have a great affect on what happens in relation to the other modules final sound or the final harmonic output of the entire software application.

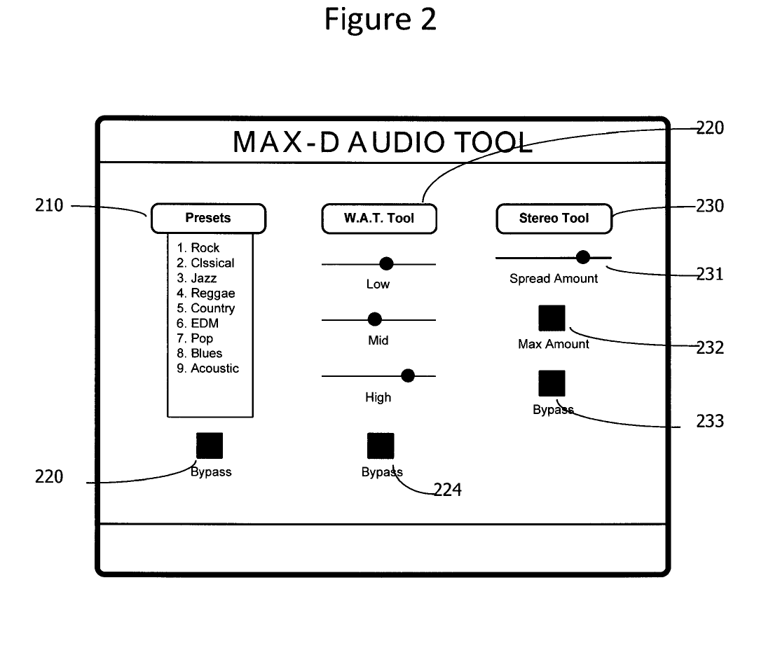

FIG. 2 shows a user interface according to an embodiment of the present invention. Source Audio (not shown) is preferably received from user's program or device. According to one embodiment there are three controls available to an end user, including Presets 210, Wave Adjustment Tool 220 and Stereo Tool 230. Preferably, there are three categories of presets available to choose from: 1) presets for different genres of music identified by numbers 1-9; 2) auto-preset that is selected by genre in metadata of playback material and 3) a single generic preset that covers all music. As one of ordinary skill in the art would appreciate, a single preset is a collective setting of all of the parameters available in this particular block. There can be a single or many sets of these settings available to an end user. This allows for the tonal optimization for different types of music in the block, just by selecting a new preset.

Wave Adjustment Tool 220 is utilized for low, mid, hi tone control. Stereo Tool 230 allows for sound field expansion in the horizontal plane. Max Amount 232 turns this part to the maximum setting and overrides the Spread Amount 231 settings. Bypass 232 allows the end user to turn a part of the process on/off . Processed Audio (not shown) is audio path that continues into user's device or is processed to output. Bypass 220, 230, 240 allow the audio to bypass the Presets, W.A.T. Tool, or Stereo Tool and go straight to the output.

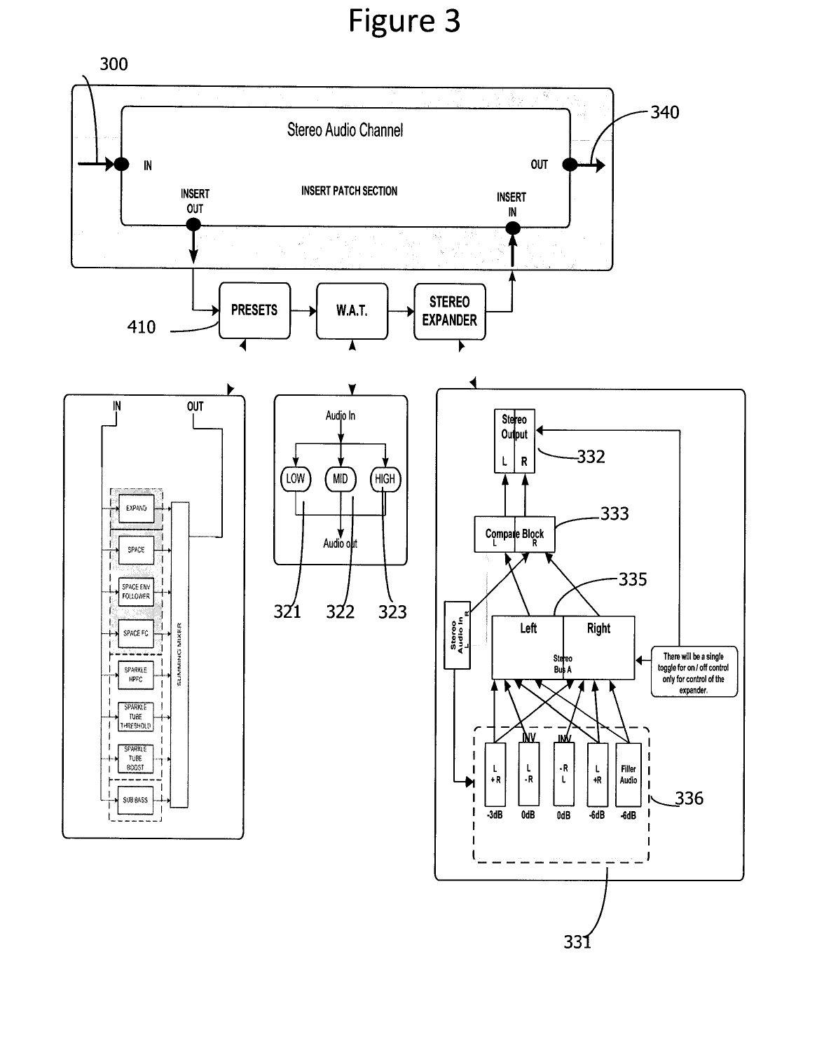

FIG. 3 depicts detailed block diagram according to an embodiment of the present invention. Input audio 300 is processed by Presets 310, WAT 320 and Stereo Expander 330 modules shown before it is outputted 340. Presetts module 310 was described by reference to FIG. 2. Output from the Presetts module 310 is received by Waye Adjustment Tool module 320 of the present invention for tone adjustment. Preset processed audio 320 is processed in parallel by the three sections of the WAT tone adjusting circuit, which include the LOW 321, MID 322 and HIGH 323 sections. The audio processed by the three sections are then mixed and fed to Stereo Expander 340.

According to one embodiment of the present invention the LOW section has a frequency of 100 Hz and a 0.5 bandwidth; MID has a frequency of 2500 Hz with an adjustable bandwidth; and HIGH has a 10 kHz frequency and an adjustable bandwidth.

For MID, the center frequency is dynamically moved in both positive and negative amounts according to the input level of this bandpass filter. Preferably, the range is from 1.7 kHz on the low end to 4.5 kHz on the upper end with 2.5 kHz as the center or nominal setting. As the input level goes positive or negative, so the bandwidth will change. For a negative change the bandwidth will increase, for e.g., to a 0.5, while a positive change will decrease, for e.g., to a 0.1. This provides a larger frequency change for negative and a smaller, more precise change for positive level amounts in the filtered audio content.

In reference to the HIGH tone control section the center frequency is fixed, e.g., at 10 kHz, but the bandwidth changes dynamically in positive amounts as the input level changes. For negative amounts the bandwidth stays at, e.g., 0.5, when the level decreases the bandwidth goes only to a max bandwidth of e.g., 0.3.

Stereo Expander module (also referred to as Stereo Tool) 340 is discussed next by reference to FIG. 3. Stereo Tool 340 can be used as standalone software if desired. It is intended to expand the spatial properties of existing audio and can be used for both digital and analog audio listening devices and playback units. The process starts by taking the incoming audio from WAT 320 and sending it into a block that splits, processes and combines the stereo stream into several different versions that are fed into the Stereo Bus A 335. This process is shown in detail in the block identified by reference numeral 331 and discussed below. Stereo Bus A 335 goes into a Compare Block 333 that adjusts the amplitude of the original and processed audio through averaging. It is noted that this is not a compressor/limiter type block. Preferably, there is a fixed ratio of 2.75 (Stereo Bus A) to 1 (Original Stereo Source) that operates in both positive and negative directions. The end result is an expanded stereo field that both expands and contracts as real audio does. Preferably, there will be a single “slider” or control that will adjust the mix of the audio from a small to large amount with only a slight gain change in the overall amplitude. In addition, the amount could be driven by an envelope follower to create a dynamic soundfield that changes according to the setting of the envelope follower.

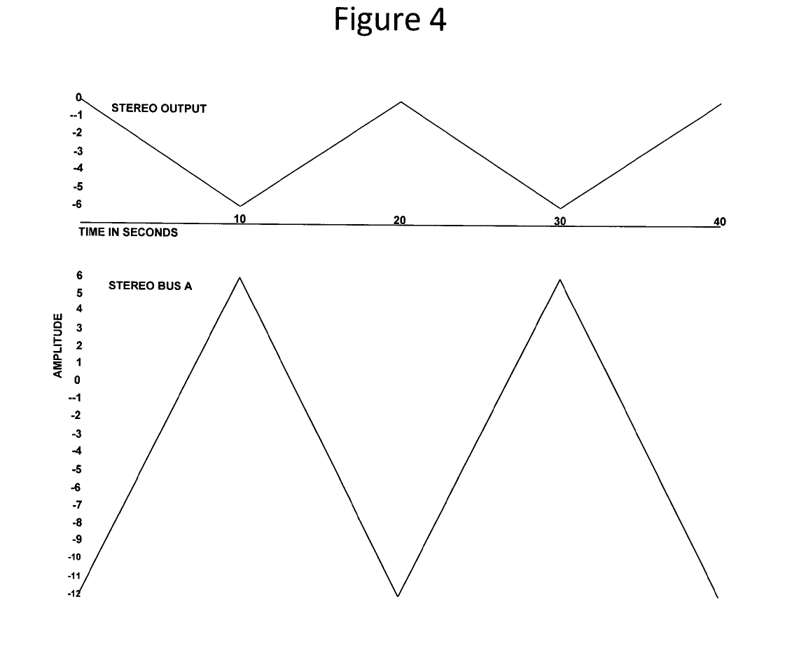

Continuing with the description of FIG. 3, output from the WAT module 320 is mixed with the processed audio identified as Stereo Bus A 335 and is fed to the Compare Block 333 where the output signal stays very close to a constant amount. There are two separate diagrams for accomplishing this and are shown in FIG. 4. As the Spread Amount (231 in FIG. 2) control moves up and down, the amounts of the Stereo Output and the Stereo Bus A changes in a corresponding amount as shown in FIG. 4 Note that this is not a compressor/limiter style of control. It follows the dB amounts shown in FIG. 4.

Next, the blocks identified in the block identified by reference numeral 336 in FIG. 3 are identified:
1. L+R—the original left and right summed together and the output panned to center.
2. L−R—the original left and right with the right inverted and summed together. The output is panned to the left.
3. −R L—the original left and right with the left inverted and summed together. The output is panned to the right.
4. L+R—the original left and right summed together and panned to the center. This level is 6 dB lower than the original.
5. Filler Audio—the original left and right summed together and the output panned to center. There is a bandpass filter set for 55 Hz to 8.5 kHz. Preferably, a delay is set for 30 ms for the left side only.

FIG. 4 is a representation of how the levels of Stereo Bus A and Stereo Output change according to each other. As one skilled in the art would appreciate, even though there are two complete cycles show, there is no modulation source; this is only to show an example of turning the control fader up and down twice. This will ensure that the output doesn't have a great increase as the Stereo Bus A level is increased.

What is claimed is:

1. A process and system for enhancing and customizing audio recording and editing comprising:
Receiving an input audio sound;
Setting a preset for the input audio sound to create a presetted audio sound;
Tone adjusting the presetted audio sound to create a tone adjusted presetted audio;
Expanding the tone adjusted presetted audio in a horizontal plane to create an presetted tone adjusted expanded audio; and
Outputting the presetted tone adjusted expanded audio.

2. The process of claim 1, wherein the presetting comprises ten or more presets corresponding to genres of music.

3. The process of claim 1, wherein the presetting comprises an auto present that is selected by genre in metadata of playback material.

4. The process of claim 1, wherein the presetting comprises a single generic preset that covers all types of music.

5. The process of claim 1, wherein the presetting comprises the parallel processing the input audio as follows:
A module that is a low pass filter with dynamic offset;
An envelope controlled bandpass filter;
A high pass filter;
Adding an amount of dynamic synthesized sub bass to the audio;
Combining the four treated audio signals in a summing mixer with the original audio.

6. A process of claim 1, wherein the tone adjustment comprises;
A first section for adjusting a low frequency tone;
A second section for adjusting a mid frequency tone;
A third section for adjusting a high frequency tone; and
Mixing the audio outputs processed by the first, second and third sections to produce an output audio sound.

7. The process of claim 6, wherein the low frequency tone has a frequency of 100 Hz and a bandwidth of 0.5.

8. The process of claim 6, wherein the mid frequency tone has a frequency of 2500 Hz and an adjustable bandwidth.

9. The process of claim 6, wherein the high frequency tone has a frequency of 10 KHz and an adjustable bandwidth.
